(19) United States
(12) Patent Application Publication
(10) Pub. No.: US 2011/0053518 A1
(43) Pub. Date: Mar. 3, 2011

(54) WIRELESS COMMUNICATION PERFORMANCE TEST METHOD, WIRELESS COMMUNICATION TEST-USE MEASUREMENT DEVICE, AND WIRELESS COMMUNICATION PERFORMANCE TEST SYSTEM

(75) Inventors: Noriaki SHINDO, Kawasaki (JP); Shigeki TAKAHASHI, Kawasaki (JP); Akio SASAKI, Kawasaki (JP); Mitsuhiko MANPO, Kawasaki (JP); Kunifumi TAMACHI, Kawasaki (JP)

(73) Assignee: Fujitsu Limited, Kawasaki (JP)

(21) Appl. No.: 12/869,030

(22) Filed: Aug. 26, 2010

(30) Foreign Application Priority Data
Sep. 1, 2009 (JP) 2009-202065

(51) Int. Cl. H04W 24/00

(52) U.S. Cl. 455/67.14

(57) ABSTRACT

A wireless communication performance test method for testing a performance of a wireless processor which is arranged in a wireless transmission device for performing a transmission and reception operation of a wireless signal, includes operations of transmitting, performing, and measuring. The operation of transmitting is for transmitting, to the wireless processor, a wireless signal including control information for controlling the transmission and reception operation performed by the wireless processor from a wireless transmission test use measurement device for measuring a wireless transmission performance of the wireless processor. The operation of performing is for performing the transmission and reception operation in the wireless processor based on the control information extracted from the wireless signal transmitted from the wireless transmission test use measurement device. The operation of measuring is for measuring the wireless signal transmitted and received in the transmission and reception operation performed by the wireless processor.

### CROSS-REFERENCE TO RELATED APPLICATION

This application is based upon and claims the benefit of priority of the prior Japanese Patent Application No. 2009-202065, filed on Sep. 1, 2009, the entire contents of which are incorporated herein by reference.

### FIELD

The present invention herein relates to a wireless communication performance test method, a wireless communication test-use measurement device, and a wireless communication performance test system.

### BACKGROUND

There has been a wireless communication performance test system, hereinafter referred to as “a performance test system”, used for testing the wireless communication performance of a wireless communication device, such as a mobile phone or a personal handy-phone system (PHS) device or the like. In the performance test system of the related art, a control personal computer (PC) and a wireless device tester are connected to the wireless communication device that is a test object. In addition, when the control PC transmits control information to the wireless communication device, the wireless communication device performs a test operation in response to the control information. As a result, data output from the wireless communication device is transferred to the control PC through the wireless device tester. Accordingly, the control PC determines the test result.

An example of the conventional performance test system will be described. Here, the example indicates a case in which a mobile phone is a test object. FIG. 13 is a diagram illustrating the configuration of the performance test system used for testing the wireless communication performance of the mobile phone. As illustrated in FIG. 13, the performance test system includes a mobile phone 510, a wireless device tester 520, and a control PC 530.

The mobile phone 510 includes a radio frequency (RF) processor 511, which performs a transmission/reception operation for an RF signal, and a baseband processor 512 that controls the operation of the RF processor 511. The RF processor 511 is the test object of the wireless communication performance test. The wireless communication performance test is referred to as “the performance test”.

The wireless device tester 520 is connected to the mobile phone 510, using an RF cable 560, and measures the transmission frequency and transmission power or the like of the RF signal transmitted from the mobile phone 510. The control PC 530 transmits control information to the mobile phone 510 through a control cable 540, and causes the RF processor 511 in the mobile phone 510 to perform a transmission operation for the RF signal. In addition, the control PC 530 transmits control information to the wireless device tester 520 through a control cable 550, and causes the wireless device tester 520 to measure the RF signal. Furthermore, the control PC 530 obtains the measurement result of the wireless device tester 520 through the control cable 550, and determines whether or not the wireless communication performance of the mobile phone 510 is acceptable, using the obtained measurement result.

Next, the operating procedures of a performance test performed in the performance test system illustrated in FIG. 13 will be described. FIG. 14 is a flowchart illustrating the operating procedures of the performance test performed in the performance test system illustrated in FIG. 13.

As illustrated in FIG. 14, power is applied to the mobile phone 510 to activate the RF processor 511 and the baseband processor 512 (Step S01). After confirming the activation of the RF processor 511 and the baseband processor 512, the control PC 530 configures, for the wireless device tester 520, an initial setting used for the performance test (Step S02). In addition, after the completion of the initial setting for the wireless device tester 520, the control PC 530 transmits the control information to the mobile phone 510 and the wireless device tester 520, thereby configuring operation settings (Step S03).

Specifically, the mobile phone 510 controls the operation of the RF processor 511 after the baseband processor 512 receives the control information from the control PC 530. For example, the baseband processor 512 causes the RF processor 511 to operate so as to transmit the RF signal of a predetermined transmission frequency and a predetermined transmission power. On the other hand, when receiving the control information from the control PC 530, the wireless device tester 520 measures the transmission frequency and the transmission power or the like of the RF signal received from the mobile phone 510, and then transmits the measurement result to the control PC 530.

When receiving the measurement result from the wireless device tester 520, the control PC 530 performs a performance test operation (Step S04). Specifically, using the measurement result received from the wireless device tester 520, the control PC 530 determines whether or not the wireless communication performance of the mobile phone 510 is acceptable. For example, when it is determined that the mobile phone 510 does not transmit the RF signal of proper transmission power, the control PC 530 modifies a setting value used for the power amplification factor of a power amplification circuit provided in the RF processor 511.

In this way, the control PC 530 performs the performance test operation under the transmission frequency and the transmission power or the like as setting conditions. The performance test operation is referred to as “the performance test operation”. In addition, while appropriately changing the setting conditions such as the transmission frequency and the transmission power or the like, the control PC 530 repeats the performance test operation (Step S05). When there is an unprocessed setting condition (Step S05 negative), the control PC 530 proceeds to the process of Step S03 and causes the same operation to be performed.

When the test is completed with respect to all setting conditions (Step S05 affirmative), the control PC 530 determines whether or not the performance test operation in Step S04 has been performed normally (Step S06). Here, when there is a setting condition in which the performance test operation is not performed normally owing to the occurrence of an error or the like (Step S06 negative), the control PC 530 performs again the performance test operation in the corresponding setting condition (Step S07).

On the other hand, when the performance test operation has been performed normally in all setting conditions (Step S06 affirmative), the control PC 530 terminates the performance test. In addition, while, for convenience of description, the test procedure for the wireless communication performance is described here, the wireless communication performance may be adjusted in similar procedures before the test is performed.

As one of the performance test methods for a mobile station, Japanese Laid-open Patent Publication No. 2004-274307 discloses a performance test system for testing between a mobile station provided in a train and a testing apparatus located in a railroad station.

### SUMMARY

According to an aspect of the invention, there is provided that a wireless communication performance test method for testing a performance of a wireless processor which is arranged in a wireless transmission device for performing a transmission and reception operation of a wireless signal, includes transmitting, to the wireless processor, a wireless signal including control information for controlling the transmission and reception operation performed by the wireless processor from a wireless transmission test use measurement device for measuring a wireless transmission performance of the wireless processor; performing the transmission and reception operation in the wireless processor based on the control information extracted from the wireless signal transmitted from the wireless transmission test use measurement device; and measuring the wireless signal transmitted and received in the transmission and reception operation performed by the wireless processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a wireless communication performance test method according to a first embodiment;

FIG. 2 is a diagram illustrating a configuration of a wireless communication performance test system according to a second embodiment;

FIG. 3 is a diagram illustrating a configuration of a wireless device tester according to the second embodiment;

FIG. 4 is a diagram illustrating configurations of an RF processor and a BB-LSI;

FIG. 5 is a diagram illustrating a configuration of a receiver in an RF-LSI;

FIG. 6 is a diagram illustrating a method in which control information is extracted from an RF control signal;

FIG. 7 is a diagram illustrating a configuration of a transmitter in the RF-LSI;

FIG. 8A is a flowchart illustrating operations performed when wireless communication performance adjustment is performed according to the second embodiment;

FIG. 8B is a flowchart illustrating operations performed when wireless communication performance test is performed according to the second embodiment;

FIG. 9 is a flowchart illustrating operations performed in the wireless device tester according to the second embodiment;

FIG. 10 is a flowchart illustrating operations performed when a wireless communication performance adjustment operation is performed according to the second embodiment;

FIG. 11 is a flowchart illustrating operations performed when a wireless communication performance test operation is performed according to the second embodiment;

FIG. 12 is a flowchart illustrating operations performed in a mobile phone according to the second embodiment;

FIG. 13 is a diagram illustrating a configuration of a wireless communication performance test system in which the wireless communication performance of a mobile phone is tested; and

FIG. 14 is a flowchart illustrating operations performed when a wireless communication performance test is performed in the wireless communication performance test system illustrated in FIG. 13.

### DESCRIPTION OF EMBODIMENTS

However, in the conventional performance test system such as one described in the background, the performance test for the RF processor 511 has to be performed through the baseband processor 512 which is unrelated to the test. Accordingly, the test detailed described in the background is inefficient. Namely, the activation of the baseband processor 512 for the test and the control on the RF processor 511 through the activated baseband processor 512 will cause a test time to be long.

In addition, in the performance test system described in the background, the notice of a setting response is sent from the mobile phone 510 to the control PC 530 whenever the control PC 530 configures an operation setting for the mobile phone 510. Therefore, in the performance test system, it takes time to wait till the notice of the setting response is sent to the control PC 530, thereby causing the test time to be long in some cases.

In addition, the performance test system performs a test for each set including the mobile phone 510, the wireless device tester 520, and the control PC 530. Accordingly, in the case in which a large number of the mobile phones 510 are tested, it is necessary to provide the same number of the control PCs 530 as the mobile phones 51. The test for a large number of the mobile phones 510 results in not only decrease in cost-efficiency but decrease in space-efficiency. In addition, these problems occur not only in the case in which the mobile phones 510 are test objects but, in a similar way, in a case in which other wireless communication devices are test objects.

Embodiments of a performance test method, a wireless communication test-use measurement device, and a performance test system, which are disclosed in the present application, will be described in detail on the basis of figures, hereinafter. In addition, the present invention is not limited to the embodiments. The wireless communication performance test method and the wireless communication test-use measurement device are referred as to the performance test method and the test-use measurement, respectively.

### First Embodiment

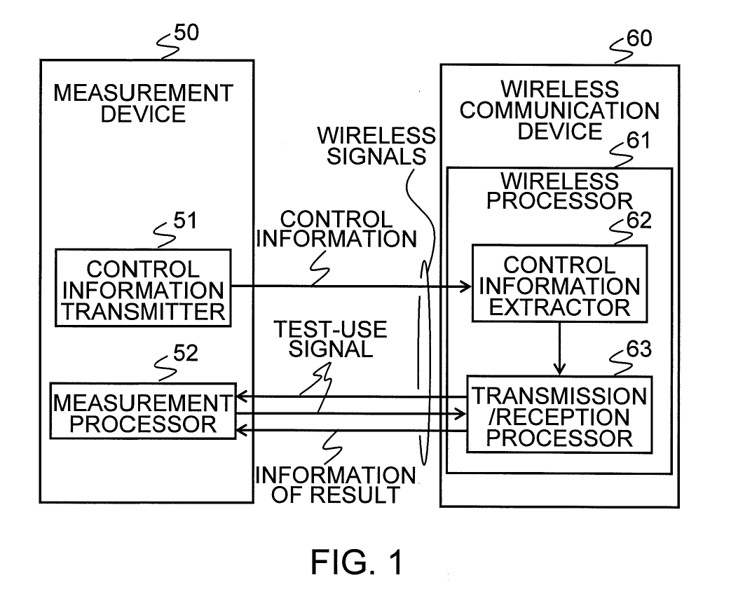

A performance test method according to a first embodiment will be described. In the performance test method according to the first embodiment, a wireless device tester mainly controls the operation of a wireless processor that is to be an object of a performance test. FIG. 1 is a diagram illustrating the performance test method according to the first embodiment.

As illustrated in FIG. 1, a test-use measurement device 50 is used for testing the wireless communication performance of a wireless communication device 60. Specifically, the test-use measurement device 50 includes a control information transmitter 51 and a measurement processor 52, the wireless communication performance measurement processor is referred as to “the measurement processor” hereinafter. The wireless communication device 60 includes a wireless processor 61 that is a test object of a performance test. The wireless processor 61 is a circuit that performs a transmission/reception operation for a wireless signal. Specifically, the wireless processor 61 includes a control information extractor 62 and a transmission/reception processor 63.

Using a wireless signal, the control information transmitter 51 transmits control information to the wireless processor 61. The control information is used for controlling the transmission/reception operation performed by the wireless processor 61. The measurement processor 52 measures the wireless signal transmitted by the wireless processor 61.

The control information extractor 62 extracts the control information from the wireless signal transmitted from the test-use measurement device 50. The transmission/reception processor 63 performs the transmission/reception operation for the wireless signal on the basis of the control information extracted by the control information extractor 62.

In the first embodiment, first, the control information transmitter 51 transmits, using the wireless signal, the control information to the wireless processor 61. When the wireless signal is received from the control information transmitter 51, the control information extractor 62 in the wireless processor 61 extracts the control information from the received wireless signal.

Then the transmission/reception processor 63 performs the transmission/reception operation for the wireless signal on the basis of the control information extracted by the control information extractor 62. For example, the transmission/reception processor 63 transmits a test-use wireless signal to the test-use measurement device 50 in accordance with the content of the control information extracted by the control information extractor 62.

In this way, the test-use measurement device 50 directly transmits a control signal to the wireless processor 61 for controlling the operation of the wireless processor 61. Therefore, the wireless processor 61 may obtain the control information without passing through a baseband processor that is unrelated to the test. As a result, in the performance test method according to the first embodiment, a test time may be reduced by omitting a time necessary for activating the baseband processor from the test time. Further, a processing time taken in the wireless communication device 60 may be reduced.

In addition, in the first embodiment, since the test-use measurement device 50 controls the wireless processor 61, it is not necessary for the individual control PCs for controlling the operations of the individual wireless communication devices 60. Therefore, cost-efficiency and installation space-efficiency may be improved even in wireless communication performance tests (performance tests) for the multiple wireless communication devices 60.

### Second Embodiment

Next, a performance test method, a test-use measurement device, and a performance test system according to a second embodiment will be described using a mobile phone as an example of a wireless communication device. In the second embodiment, a following case will be described. The case is a performance test of a wireless communication performance adjustment operation for correcting variation in the wireless communication performance of an RF processor and a test of a wireless communication performance of the RF processor. The wireless communication performance test or performance test is referred to as wireless adjustment/test or adjustment/test hereinafter.

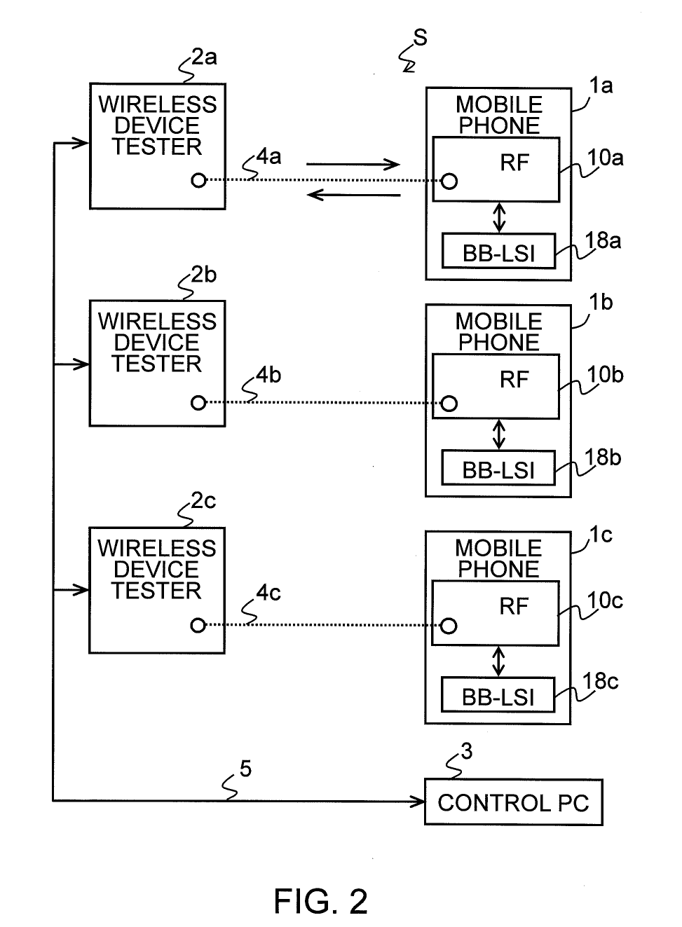

FIG. 2 is a diagram illustrating the configuration of the performance test system S according to the second embodiment in which mobile phones 1a to 1c, wireless device testers 2a to 2c, and a control PC 3 are included.

In the performance test system S, the wireless device testers 2a to 2c are connected to the mobile phones 1a to 1c through RF cables 4a to 4c, respectively, and are connected to the control PC 3 through a control cable 5. In this way, one control PC 3 is provided for the multiple mobile phones 1a to 1c and the multiple wireless device testers 2a to 2c in the performance test system S. The control cable 5 may be, for example, a universal serial bus (USB) cable or a general purpose interface bus (GPIB) cable.

The mobile phones 1a to 1c include RF processors 10a to 10c and baseband-large scale integration circuits (BB-LSI) 18a to 18c, respectively. The RF processors 10a to 10c perform transmission/reception operations for RF signals used as wireless signals. The baseband-large scale integration circuits 18a to 18c control the operations of the RF processors 10a to 10c, respectively. The RF processors 10a to 10c are the test objects of the performance test. For example, when the performance test is performed, the RF processors 10a to 10c transmit test-use RF signals to the wireless device testers 2a to 2c and receive test-use RF signals transmitted from the wireless device testers 2a to 2c, respectively.

The wireless device testers 2a to 2c are test-use measurement devices for testing the wireless communication performance of the RF processors 10a to 10c, respectively. The wireless device testers 2a to 2c measure the transmission frequencies and transmission power values or the like of the RF signals transmitted from the RF processors 10a to 10c and transmit the test-use RF signals to the RF processors 10a to 10c, respectively. The control PC 3 is a control device for controlling the operations of the wireless device testers 2a to 2c.

In the performance system S, the wireless device testers 2a to 2c, instead of from BB-LSIs 18a to 18c, send control information in a form of RF signals used for controlling the operations of the RF processors 10a to 10c. Upon receiving the RF signals, the RF processors 10a to 10c extract the control information from the received RF signals and perform test operations in accordance with the content of the extracted control information. Namely, the RF processors 10a to 10c according to the second embodiment perform the transmission/reception operations for the RF signals on the basis of control performed by the wireless device testers 2a to 2c instead of control performed by the BB-LSIs 18a to 18c.

In this way, in the performance test system S, it is not necessary for the RF processors 10a to 10c to control the BB-LSIs 18a to 18c. Accordingly, a test time may be reduced by omitting a time necessary for activating the BB-LSIs 18a to 18c from the test time and a processing time taken in the mobile phones 1a to 1c may be reduced.

In addition, in the performance test system S, the control PC 3 controls the wireless device tester 2 only at the time of start of the wireless adjustment/test or when data is read out after termination of the wireless adjustment/test. Therefore, the control PC 3 may easily control the multiple wireless device testers 2a to 2c.

Next, it will be described as follows on the configurations of the mobile phones is to is and the wireless device testers 2a to 2c. Any one of the mobile phones is to is will be simply referred to as “mobile phone 1”, hereinafter. In a similar way, any one of the wireless device testers 2a to 2c will be simply referred to as “wireless device tester 2”, and any one of the RF cables 4a to 4c will be simply referred to as “RF cable 4”.

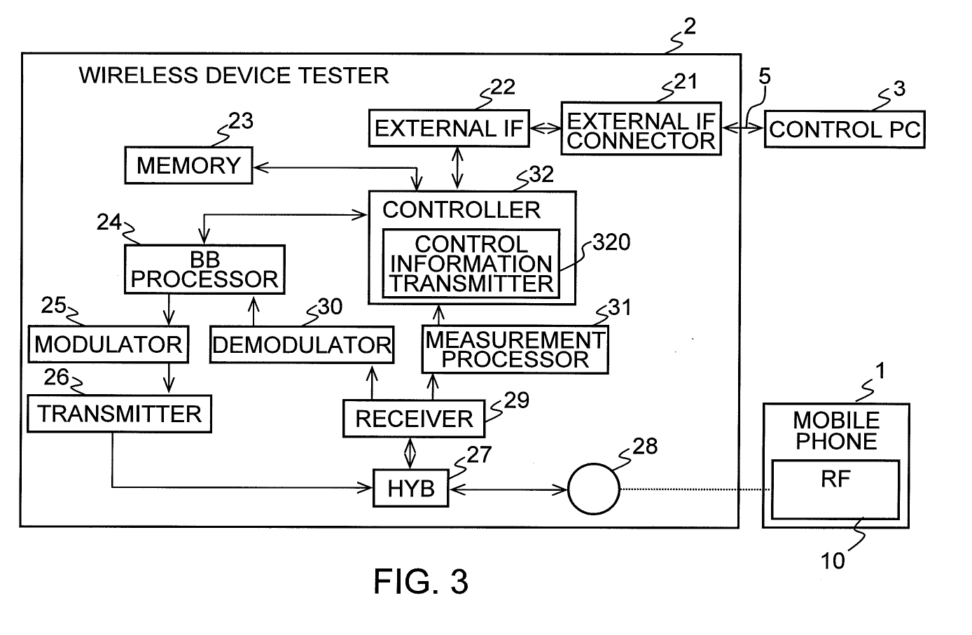

First, the configuration of the wireless device tester 2 will be described. FIG. 3 is a diagram illustrating the configuration of a wireless device tester 2 according to the second embodiment. FIG. 3 illustrates that the wireless device tester 2 includes an external interface (IF) connector 21, an external IF 22, a memory 23, a BB processor 24, a modulator 25, and a transmitter 26. In addition, the wireless device tester 2 includes a hybrid device (HYB: a signal branch device) 27, a transmission/reception connector 28, a receiver 29, a demodulator 30, a measurement processor 31, and a controller 32.

The external IF connector 21 is a connector used for connecting the wireless device tester 2 to the control PC 3. The external IF 22 transfers a signal from the external IF connector 21 to the controller 32 and vice versa. The memory 23 is a storage device, such a random access memory (RAM), a read only memory (ROM), or a hard disk drive (HDD) or the like, and stores the procedures of the wireless adjustment/test or the like.

The BB processor 24 generates a transmission signal to be sent to the RF processor 10. The BB processor 24 also extracts information, such as a measurement result or the like, from a signal input from the demodulator 30 and transfers the information to the controller 32. The modulator 25 modulates a signal from the BB processor 24. The transmitter 26 converts a signal from the modulator 25 to an RF signal to send the converted RF signal into the HYB 27.

The HYB 27 outputs the signal from the transmitter 26 to the transmission/reception connector 28 used for connecting the wireless device tester 2 to the mobile phone 1. Further, the HYB 27 outputs a signal from the transmission/reception connector 28 to the receiver 29. The receiver 29 converts and amplifies the signal from the HYB 27 to send the processed signal to the demodulator 30 or the measurement processor 31. The demodulator 30 demodulates the signal from the receiver 29 to send the demodulated signal the BB processor 24.

The measurement processor 31 measures the wireless communication performance of the RF processor 10. Specifically, the measurement processor 31 measures the transmission frequency and the transmission power or the like of the test-use RF signal transmitted from the RF processor 10 and outputs the measurement result to the controller 32. In addition, the measurement processor 31 receives the test-use RF signal transmitted from the RF processor 10 through the RF cable 4, the transmission/reception connector 28, the HYB 27, and the receiver 29.

The controller 32 is a central processing unit (CPU) or the like and totally controls the wireless device tester 2. In particular, the controller 32 includes a control information transmitter 320. The control information transmitter 320 transmits to the RF processor 10 an RF control signal used for controlling the operation of the RF processor 10. Here, it will be described on a transmission operation for the RF control signal performed by the control information transmitter 320.

When the RF control signal is transmitted to the RF processor 10, first, the control information transmitter 320 amplitude modulates control information to generate the RF control signal. Specifically, the operation of the RF processor 10 is controlled by the control information composed with bit data that includes a value “1” or a value “0”. In addition, the control information transmitter 320 switches between a high output level and a low output level in the amplitude level of the signal transmitted to the RF processor 10, and assigns the values “1” and “0” to the high output level and the low output level, respectively. The control information transmitter 320 transmits to the RF processor 10 the control information of bit data as an analog signal. In addition, the switching in the amplitude level is performed by the modulator 25.

In this way, in the performance test system S, the wireless device tester 2 transmits to the RF processor 10 the control information used for controlling the operation of the RF processor 10. Therefore, two kinds of RF signals, that is, the test-use RF signal and the RF control signal, are transmitted to the RF processor 10.

Accordingly, in order to cause the RF processor 10 to distinguish whether the transmitted RF signal is the test-use RF signal or the RF control signal, the control information transmitter 320 transmits an RF signal with a predetermined amplitude level before transmitting the RF control signal to the RF processor 10. Specifically, before transmitting the RF control signal to the RF processor 10, the control information transmitter 320 transmits an RF signal having an amplitude level more than or equal to −30 dBm for not less than a predetermined period of time. Then the control information transmitter 320 transmits an RF signal having an amplitude level less than or equal to −90 dBm for not less than a predetermined period of time.

The controller 32 transmits the test-use RF signal to the RF processor 10 in accordance with the procedures of the wireless adjustment/test, stored in the memory 23. Specifically, the controller 32 transmits the test-use RF signal to the RF processor 10 by controlling the BB processor 24, the modulator 25, and the transmitter 26.

Upon receiving the measurement result information from the BB processor 24 or the measurement processor 31, the controller 32 determines whether or not it is necessary to adjust the wireless communication performance of the RF processor 10. Specifically, the controller 32 determines whether or not the test-use RF signal transmitted from the RF processor 10 is normally transmitted using the transmission frequency and the transmission power or the like, specified by the RF control signal. In addition, the controller 32 determines whether or not the RF processor 10 receives the test-use RF signal having the normal reception frequency and the normal reception power or the like. In addition, when it is determined that it is necessary to adjust the wireless communication performance of the RF processor 10, the controller 32 transmits the RF control signal used for wireless communication performance adjustment to the RF processor 10 to cause the RF processor 10 to adjust the wireless communication performance.

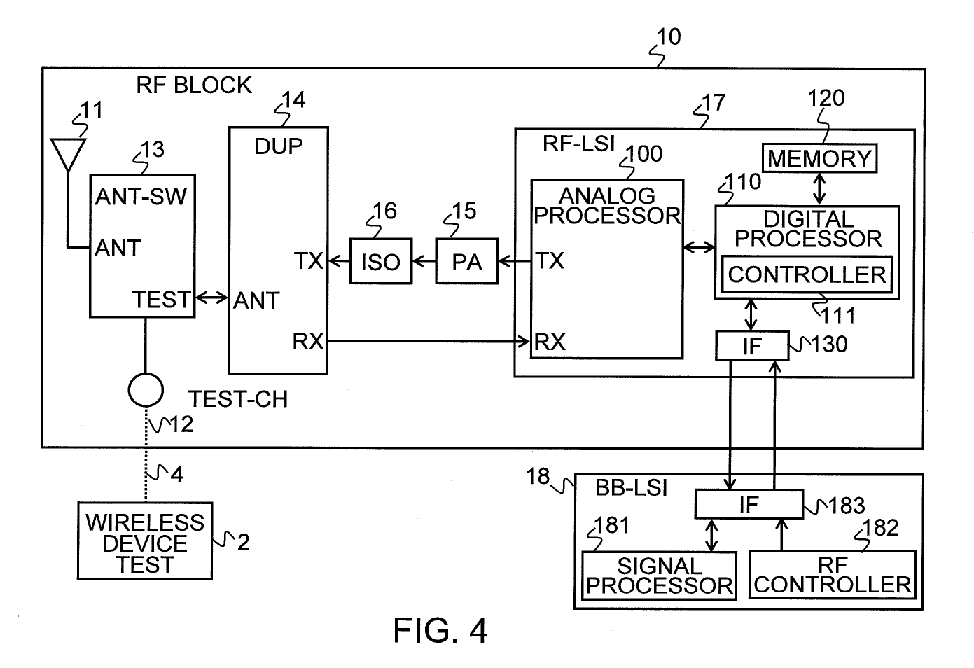

It will be described on the configurations of the RF processor 10 and the BB-LSI 18 included in the mobile phone 1. FIG. 4 is a block diagram illustrating the configurations of the RF processor 10 and the BB-LSI 18.

As illustrated in FIG. 4, the RF processor 10 includes an antenna (ANT) 11, a test-channel (TEST-CH) 12, an antenna-switch (ANT-SW) 13, a duplexer (DUP: antenna duplexer) 14, a power amplifier (PA) 15, and an isolator (ISO: power transfer device) 16. The RF processor 10 includes an RF-LSI 17.

The ANT 11 is an antenna that transmits and receives an RF signal. The TEST-CH 12 is a connector used for a performance test, which is used when the wireless device tester 2 is connected to the RF processor 10. The ANT-SW 13 selectively outputs the RF signal for transmission to any one of the ANT 11 and the TEST-CH 12. The DUP 14 outputs a transmission signal from the PA 15 to any one of the ANT 11 and the TEST-CH 12. In addition, the DUP 14 outputs a reception signal from any one of the ANT 11 and the TEST-CH 12 to the RF-LSI 17. The PA 15 amplifies the transmission power of the transmission signal from the RF-LSI 17. The ISO 16 causes the transmission signal to be transmitted only in one direction.

The RF-LSI 17 is an integrated circuit that mainly controls the operation of the RF processor 10. Specifically, the RF-LSI 17 includes an analog processor 100, a digital processor 110, a memory 120, and an intermediate frequency (IF) converter 130.

The analog processor 100 performs an analog process for a transmission signal (TX signal) and a reception signal (RX signal). Specifically, the analog processor 100 converts the TX signal to an RF signal, where the TX signal is input from the digital processor 110. The analog processor 100 also amplifies and modulates the RX signal input from the DUP 14.

The digital processor 110 converts the RX signal from the analog processor 100 from an analog form to a digital form and a signal input from the IF convertor 130 from a digital form to an analog form. In addition, the digital processor 110 includes a controller 111 that totally controls the RF processor 10. The controller 111 is a CPU or the like.

The memory 120 is a semiconductor memory device such as a RAM, a ROM, or a flash memory. The IF convertor 130 modulates and demodulates an IF signal from the digital processor 110 or the BB-LSI 18.

The BB-LSI 18 includes a signal processor 181, an RF controller 182, and an IF convertor 183. The signal processor 181 generates the TX signal. In addition, the signal processor 181 converts a signal from the RF-LSI 17 to an audio signal or data. The RF controller 182 generates control information used for controlling the operation of the RF-LSI 18. The IF convertor 183 modulates and demodulates signals from the signal processor 181, the RF controller 182, and the RF-LSI 17.

The RF processor 10 according to the second embodiment performs a transmission/reception operation for the RF signal on the basis of the RF control signal transmitted from the wireless device tester 2. Therefore, in the performance test system S, it is not necessary for the BB-LSI 18 to control the RF processor 10

Specifically, the RF processor 10 receives the RF control signal transmitted from the wireless device tester 2 through the TEST-CH 12. The RF control signal is input into the analog processor 100 through the ANT-SW 13 and the DUP 14.

After Upon receiving the RF control signal, the analog processor 100 analog-processes the RF control signal and feeds the RF control signal to the digital processor 110. Then the controller 111 extracts control information from the RF control signal.

The controller 111 controls the operation of the RF processor 10 in accordance with the extracted control information. For example, when the content of the control information indicates the transmission of the test-use RF signal, the controller 111 transmits the test-use RF signal to the wireless device tester 2. The control information may include information specifying the transmission frequency and the transmission power or the like of the RF signal to be transmitted. Accordingly, the controller 111 transmits the test-use RF signal with the transmission frequency and the transmission power or the like specified by the control information.

After being generated by the controller 111, the test-use RF signal is DA-converted by the digital processor 110 and output to the analog processor 100. Then, the test-use RF signal is converted to an RF signal by the analog processor 100 and amplified by the PA 15. The test-use RF signal is transmitted from the TEST-CH 12 to the wireless device tester 2 through the ISO 16, the DUP 14, and the ANT-SW 13.

When the content of the control information indicates that the test-use RF signal is to be received, the controller 111 moves to a reception standby state in which the controller 111 stands by for the reception of the test-use RF signal transmitted from the wireless device tester 2. When receiving the test-use RF signal transmitted from the wireless device tester 2, the controller 111 measures the frequency and the power or the like of the test-use RF signal and transmits the measurement result to the wireless device tester 2.

When the content of the control information indicates that the wireless communication performance of the RF processor 10 is to be adjusted, the controller 111 adjusts the wireless communication performance of the RF processor 10 in accordance with the content of the control information. For example, the controller 111 adjusts the transmission power of the RF signal in a manner of modifying a setting value used for the power amplification factor in the PA 15 for the RF signal.

In addition, at times other than the wireless adjustment/test, the RF processor 10 operates on the basis of control performed by the BB-LSI 18. For example, the BB-LSI 18 generates control information for the RF-LSI 17 using the RF controller 182, and outputs the control information to the RF-LSI 17 through the IF convertor 183. Upon receiving the control information from the RF controller 182, the RF-LSI 117 controls the operation of the RF processor 10 in accordance with the content of the received control information.

At times other than the wireless adjustment/test, the BB-LSI 18 generates the TX signal by use of the signal processor 181 and feeds the TX signal into the digital processor 110 through the IF convertors 183 and 130. Upon receiving the TX signal, the digital signal processor 110 converts the TX signal into digital form. Then the analog processor converts the TX signal in digital into a RF signal which is fed to the ANT 11 through the PA 15, the ISO 16, the DUP 14, and the ANT-SW 13. Form the ANT 11, the RF signal is output.

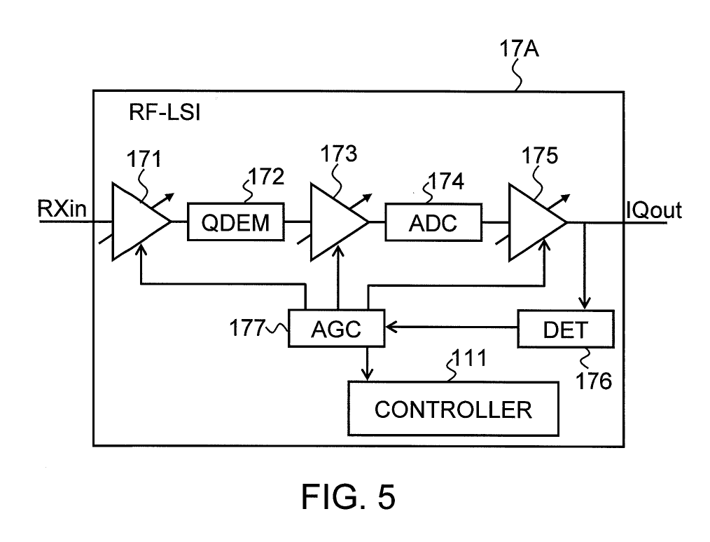

The more detailed configuration of the RF-LSI 17 will be described. First, the configuration of a receiver in the RF-LSI 17 will be described with reference to FIG. 5, in which the configuration of the receiver in the RF-LSI is illustrated.

As illustrated in FIG. 5, a receiver 17A in the RF-LSI 117 includes a low-noise amplifier (LNA) 171, a quadrature demodulator (QDEM) 172, and an analog variable gain amplifier (VGA) 173. In addition, the receiver 17A includes an analog-digital converter (ADC) 174, a digital VGA 175, a detector (DET) 176, an auto gain controller (AGC) 177, and a controller 111.

The LNA 171 amplifies an RF signal (RXin) from the DUP 14. The QDEM 172 converts the frequency of a signal from the LAN 171. The analog VGA 173 amplifies a signal from the QDEM 172. The ADC 174 converts a signal from the analog VGA 173 to a digital signal. The digital VGA 175 amplifies a signal from the ADC 174. An output signal (IQ signal) from the ADC 174 is fed as IQout into the digital processor 110. Here, the IQ signal output from the ADC 174 includes information of the phase and the amplitude or the like of the RF signal received by the ANT 11.

The DET 176 detects the amplitude level of the IQ signal output from the ADC 174 and inputs the amplitude level into the AGC 177. According to the amplitude level of the IQ signal, the AGC 177 feedback-controls amplification factors used for amplifying signals in the LAN 171, the analog VGA 173, and the digital VGA 174. In the second embodiment, using AGC function described above, control information is extracted from the RF control signal.

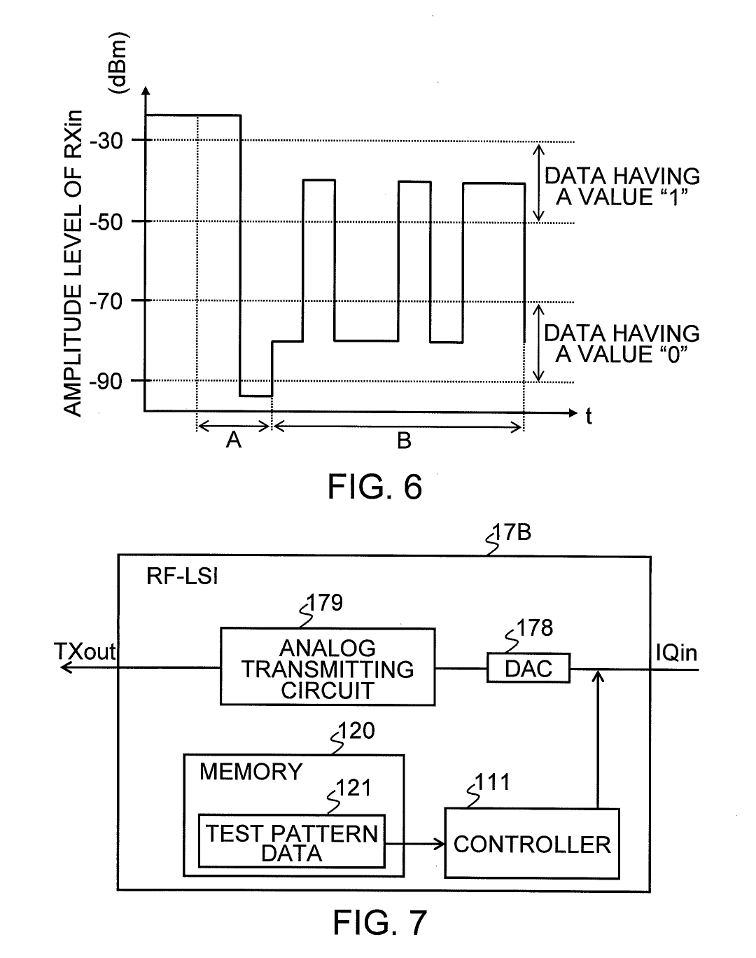

Specifically, through the AGC 177, the controller 111 obtains amplitude level information relating to the amplitude level of the IQ signal, detected by the DET 176. In addition, the controller 111 extracts control information as bit data from the RF control signal on the basis of the obtained amplitude level information. It will be described on an example of an operation in which the control information is extracted from the RF control signal received from the wireless device tester 2. FIG. 6 is a diagram illustrating a method in which the control information is extracted from the RF control signal. In FIG. 6, a vertical axis indicates the amplitude level of the RX signal detected by the DET 176, and a horizontal axis is a time scale.

In a period A in FIG. 6, the controller 111 starts a control information extraction operation when the controller 111 receives a signal having an amplitude level more than or equal to −30 dBm for more than a predetermined period of time, and, after that, receives a signal having an amplitude level less than or equal to −90 dBm for more than a predetermined period of time.

Once starting the control information extraction operation, in a period B in FIG. 6, the controller 111 recognizes the RF signal as data having a value “1”, in the case in which the amplitude level of the RF signal is from −50 dBm to −30 dBm after the control information extraction operation is started. The controller 111 recognizes the RF signal as data having a value “0”, in the case in which the amplitude level of the RF signal is from −90 dBm to −70 dBm after the control information extraction operation is started. In this way, the controller 111 recognizes the received RF signal as bit data.

In the example illustrated in FIG. 6, the amplitude level of the RF signal has values −80 dBm, −40 dBm, −80 dBm, −80 dBm, −40 dBm, −40 dBm, and −40 dBm, in order, after the control information extraction operation is started. In this case, the controller 111 recognizes the RF signal as 8-bit control information having a value “01001011”. In this way, by extracting the control information from the RF control signal received from the wireless device tester 2, the RF-LSI 17 may operate without control from the BB-LSI 18.

In addition, the controller 111 transmits information of the amplitude level of the IQ signal detected by DET 176 as the measurement result of the test-use RF signal transmitted from the wireless device tester 2.

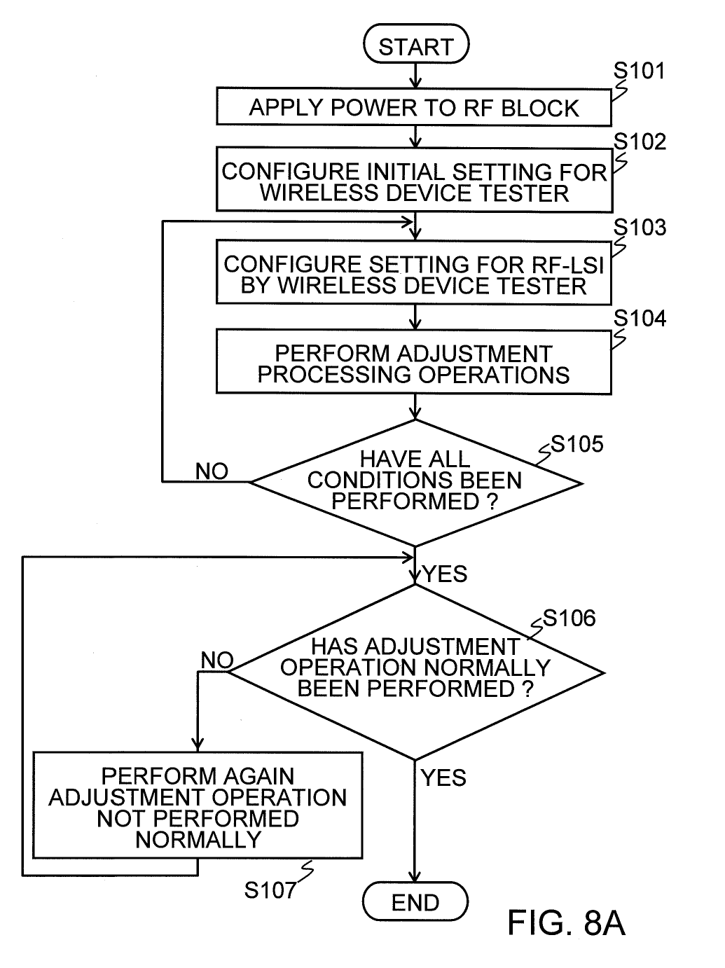

The configuration of a transmitter in the RF-LSI 17 will be described with reference to FIG. 7 illustrating the configuration of the transmitter in the RF-LSI 17. As illustrated in FIG. 7, a transmitter 17B in the RF-LSI 17 includes a digital-analog convertor (DAC) 178, an analog transmission circuit 179, a controller 111, and a memory 120.

The DAC 178 converts the IQ signal (IQin) from the digital processor 110 to an analog signal. The analog transmission circuit 179 converts the analog signal from the DAC 178 to an RF signal. The RF signal (TXout) output from the analog transmission circuit 179 is input into the PA 15 illustrated in FIG. 4.

The memory 120 stores a test pattern data 121. The test pattern data 121 is random pattern data such as PN 9 data or PN 15 data. The random pattern data is data used as a test signal used for the performance test. For example, the PN 9 data is a random pattern data having a length of 2 raised to the 9th power, that is, 2⁹.

According to the content of the control information extracted from the RF control signal, the controller 111 generates a digital IQ signal, using the test pattern data 121 stored in the memory 120. The digital IQ signal is converted into an analog signal by the DAC 178. And then the digital IQ signal is converted into the RF signal by the analog transmission circuit 179 and is output to the PA 15. As illustrated in FIG. 4, the RF signal output to the PA 15 is transmitted to the wireless device tester 2 through the ISO 16, the DUP 14, the ANT-SW 13, and the TEST-CH 12.

In this way, storing the test pattern data 121 in the memory 120 allows the RF-LSI 17 to generate the test-use RF signal without using the BB-LSI 18.

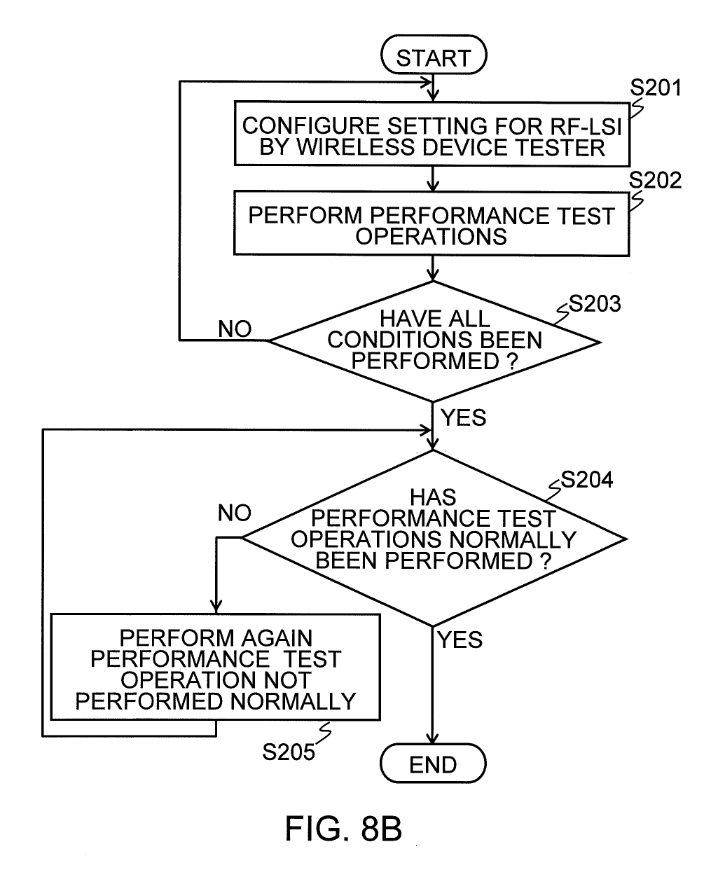

Next, it will be described on the operating procedures of the wireless adjustment/test in the performance test system according to the second embodiment. First, operating procedures performed at performing wireless communication performance adjustment will be described with reference to FIG. 8A.

As illustrated in FIG. 8A, when power is applied to the RF processor 10 (Step S101), the RF processor 10 is activated. After confirming that the RF processor 10 is activated, the control PC 3 configures an initial setting for the wireless device tester 2 (Step S102). Specifically, by transmitting initial setting information with instruction for the wireless device tester 2 to start the wireless adjustment/test, the control PC 3 causes the wireless device tester 2 to start an operation performed at the time of the wireless adjustment/test.

When starting the operation for the wireless adjustment/test, the wireless device tester 2 transmits the RF control signal to the RF-LSI 17, thereby configuring an operation setting (Step S103). For example, the wireless device tester 2 transmits to the RF-LSI 17 the RF control signal including the information indicating that the test-use RF signal is to be transmitted with a predetermined transmission frequency and predetermined transmission power or the like. Upon receiving the RF control signal, the RF-LSI 17 extracts the control information and transmits the test-use RF signal with the predetermined transmission frequency and the predetermined transmission power or the like according to the content of the extracted control information.

When the operation setting for the RF-LSI 17 is completed, a wireless communication performance adjustment operation is performed (Step S104). For example, the wireless device tester 2 measures the transmission frequency and the transmission power or the like of the test-use RF signal transmitted from the RF processor 10. The wireless device tester 2 compares the transmission frequency and the transmission power or the like as the measurement result, with the transmission frequency and the transmission power or the like specified by the RF control signal. Depending on the result of the comparison, the wireless device tester 2 determines whether or not the RF processor 10 has transmitted the RF signal using the specified transmission frequency and the specified transmission power or the like.

When it is determined that the RF processor 10 has not transmitted the RF signal using the specified transmission frequency and the specified transmission power or the like, the wireless device tester 2 adjusts the wireless communication performance of the RF processor 10. For example, the wireless device tester 2 transmits to the RF-LSI 17 the RF control signal which includes the information for modifying the setting value of the power amplification factor used in the PA 15 in the RF processor 10. Upon receiving the RF signal, the RF-LSI 17 modifies the setting value of the power amplification factor used in the PA 15 in accordance with the content of the received RF control signal.

In this way, the wireless device tester 2 performs the wireless communication performance adjustment operation under the setting conditions of the transmission frequency and the transmission power or the like. The wireless device tester 2 repeats the wireless communication performance adjustment operation with appropriately changing the transmission frequency and the transmission power or the like (Step S105). When there is an unprocessed setting condition (Step S105 negative), the wireless device tester 2 proceeds to Step S103 and causes the same operation to be performed.

On the other hand, when the wireless communication performance adjustment operation is completed with respect to all setting conditions (Step S105 affirmative), the wireless device tester 2 determines whether or not the wireless communication performance adjustment operation has been performed normally (Step S106). Here, when there is a setting condition in which the wireless communication performance adjustment operation is not performed normally owing to the occurrence of an error or the like (Step S106 negative), the wireless device tester 2 performs again the wireless communication performance adjustment operation in the corresponding setting condition (Step S107). On the other hand, when the wireless communication performance adjustment operation has been performed normally in all setting conditions (Step S106 affirmative), the wireless device tester 2 terminates the wireless communication performance adjustment.

When the wireless communication performance adjustment is terminated, the performance test is performed. FIG. 8B is a flowchart illustrating operating procedures performed when the performance test is performed according to the second embodiment. Here, the performance test is a test in which it is determined whether or not the wireless communication performance of the RF processor 10 has been correctly adjusted in the wireless communication performance adjustment, and basically is a similar operation as the wireless adjustment operation.

As illustrated in FIG. 8B, when the performance test is started, first, the wireless device tester 2 configures an operation setting for the RF-LSI 17 (Step S201), and then the performance test for the RF processor 10 is performed (Step S202). These operations are the same as the operations in Steps S103 and S104 illustrated in FIG. 8A.

Following this, the wireless device tester 2 repeats the performance test operation with appropriately changing the transmission frequency and the transmission power or the like (Step S203). When there is an unprocessed setting condition (Step S203 negative), the wireless device tester 2 performs the operations in Steps S201 and 202 with respect to the unprocessed setting condition.

On the other hand, when the performance test operation is completed with respect to all setting conditions (Step S203 affirmative), the wireless device tester 2 determines whether or not the performance test has been performed normally (Step S204). When there is a setting condition in which the performance test operation is not performed normally owing to the occurrence of an error or the like (Step S204 negative), the wireless device tester 2 performs again the performance test operation in the corresponding setting condition (Step S205). On the other hand, when the performance test operation is completed with respect to all setting conditions (Step S204 affirmative), the wireless device tester 2 terminates the performance test.

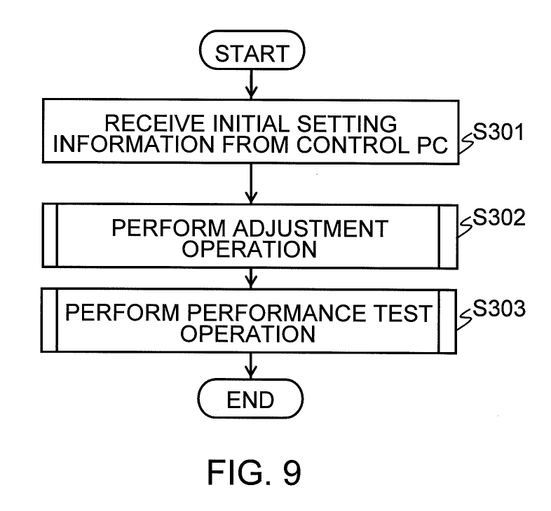

Next, the detailed operation of the wireless device tester 2 will be described with referred to FIG. 9 which illustrates operating procedures performed in a wireless device tester 2 according to the second embodiment. In FIG. 9, only operating procedures relating to the wireless adjustment/test are illustrated from among operating procedures performed by the wireless device tester 2.

As illustrated in FIG. 9, when receiving initial setting information from the control PC 3 (Step S301), the controller 32 performs the wireless communication performance adjustment operation (Step S302). Furthermore, after the wireless communication performance adjustment operation, the controller 32 performs the performance test operation (Step S303). When terminating the performance test operation, the controller 32 transmits data, which relates to the measurement result and the result of the wireless communication performance adjustment or the like, to the control PC 3 and terminates operating procedures relating to the wireless adjustment/test.

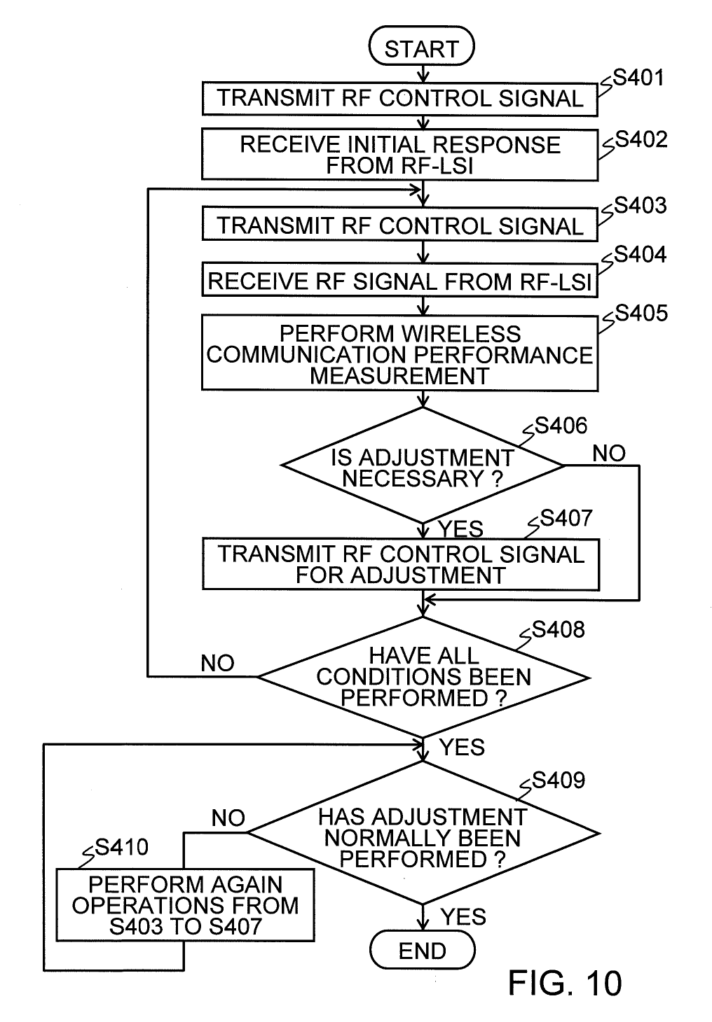

The operating procedures of the wireless communication performance adjustment operation illustrated in Step S302 will be described with referred to FIG. 10 which illustrates a flowchart of the operating procedures of the wireless communication performance adjustment operation according to the second embodiment.

As illustrated in FIG. 10, when starting the wireless communication performance adjustment operation, first, the wireless device tester 2 transmits to the RF-LSI 17 the RF control signal indicating the start of the wireless adjustment/test (Step S401). In addition, in order to wait for an initiation response of the wireless adjustment/test from the RF-LSI 17, the wireless device tester 2 continues to transmit to the RF-LSI 17 the RF control signal indicating the start of the wireless adjustment/test.

When receiving the initiation response of the wireless adjustment/test from the RF-LSI 17 (Step S402), the wireless device tester 2 determines that synchronization is established between the wireless device tester 2 and the RF-LSI 17, and goes to the operation of Step S403. In Step S403, the wireless device tester 2 transmits to the RF-LSI 17 the RF control signal used for an operation setting. When testing the wireless reception performance of the RF processor 10, the wireless device tester 2 transmits to the RF-LSI 17 the RF signal indicating that the RF-LSI 17 is to move to a reception standby state for the reception of the RF signal, and then transmits the test-use RF signal to the RF-LSI 17.

When receiving the RF signal from the RF-LSI 17 (Step S404), the wireless device tester 2 performs wireless communication performance measurement (Step S405). Specifically, when the RF signal from the RF processor 10 is the test-use RF signal, the wireless device tester 2 measures the transmission frequency and the transmission power or the like of the received RF signal, using the measurement processor 31. In addition, when the RF signal received from the RF processor 10 is the RF signal indicating the measurement result of the RX signal measured in the RF-LSI 17, the wireless device tester 2 extracts measurement result information from the RF signal.

When the wireless communication performance measurement is completed, the controller 32 determines whether or not it is necessary for the wireless communication performance of the RF processor 10 to be adjusted (Step S406). Specifically, the controller 32 compares the transmission frequency and the transmission power correspond to the measurement result with the transmission frequency and the transmission power specified by the RF control signal. Using this comparison, the controller 32 confirms whether or not the RF processor 10 has transmitted the RF signal with the normal transmission frequency and the normal transmission power or the like.

When the RF processor 10 has not transmitted the RF signal with the specified transmission frequency and the specified transmission power, the wireless device tester 2 determines that it is necessary for the wireless communication performance of the RF processor 10 to be adjusted (Step S406 affirmative). When it is determined that it is necessary for the wireless communication performance of the RF processor 10 to be adjusted, the wireless device tester 2 transmits the RF control signal used for wireless communication performance adjustment to the RF-LSI 17 (Step S407).

Depending on the completion of the operation in Step S407 or on the determination of no adjustment for the wireless communication performance in Step S406 (Step S406 negative), the controller 32 determines whether or not the adjustment operation is completed with respect to all setting conditions (Step S408). When there is an unprocessed setting condition (Step S408 negative), the wireless device tester 2 turns to Step S403 and causes the same operation to be performed with respect to the unprocessed setting condition.

On the other hand, when it is determined that the adjustment operation is completed with respect to all setting conditions (Step S408 affirmative), the wireless device tester 2 determines whether or not the wireless communication performance adjustment has been performed normally (Step S409). Here, when there is a setting condition in which the wireless communication performance adjustment is not performed normally owing to the occurrence of an error or the like (Step S409 negative), the wireless device tester 2 performs again the operations in Steps S403 to S407 with respect to the corresponding setting condition (Step S410). On the other hand, when the wireless communication performance adjustment operation has been performed normally (Step S409 affirmative), the wireless device tester 2 terminates the wireless communication performance adjustment operation.

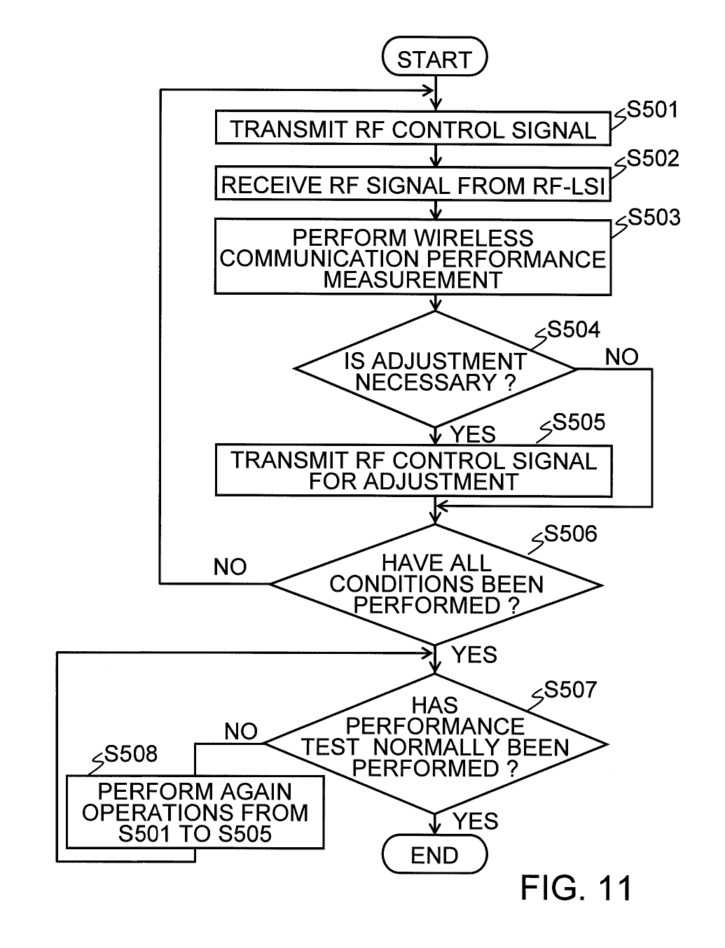

With reference to FIG. 11, it will be described on the performance test operation illustrated in Step S303. FIG. 11 is a flowchart illustrating operating procedures performed when the performance test operation is performed according to the second embodiment. Here, in the performance test operation illustrated in FIG. 11, the similar operations as those in Steps S403 to S410 illustrated in FIG. 10.

Specifically, in Step S501, the wireless device tester 2 transmits to the RF-LSI 17 the RF control signal used for an operation setting. When receiving the RF signal from the RF-LSI 17 (Step S502), the wireless device tester 2 performs wireless communication performance measurement (Step S503), and determines whether or not it is necessary for the wireless communication performance of the RF processor 10 to be adjusted (Step S504). In addition, when it is determined that it is necessary for the wireless communication performance of the RF processor 10 to be adjusted (Step S504 affirmative), the wireless device tester 2 transmits the RF control signal used for wireless communication performance adjustment to the RF-LSI 17 (Step S505).

Depending on the completion of the operation in Step S505 or on the determination of no adjustment for the wireless communication performance (Step S504 negative), the controller 32 determines whether or not the adjustment operation is completed with respect to all setting conditions (Step S506). In addition, when there is an unprocessed setting condition (Step S506 negative), the wireless device tester 2 turns to Step S501 and causes the same operation to be performed.

On the other hand, when it is determined that the adjustment operation is completed with respect to all setting conditions (Step S506 affirmative), the wireless device tester 2 determines whether or not the performance test operation has been performed normally (Step S507). When there is a setting condition in which the performance test operation is not performed normally owing to the occurrence of an error or the like (Step S507 negative), the wireless device tester 2 performs again the operations in Steps S501 to S505 with respect to the corresponding setting condition (Step S508). On the other hand, when the performance test operation has been performed normally (Step S507 affirmative), the wireless device tester 2 terminates the performance test operation.

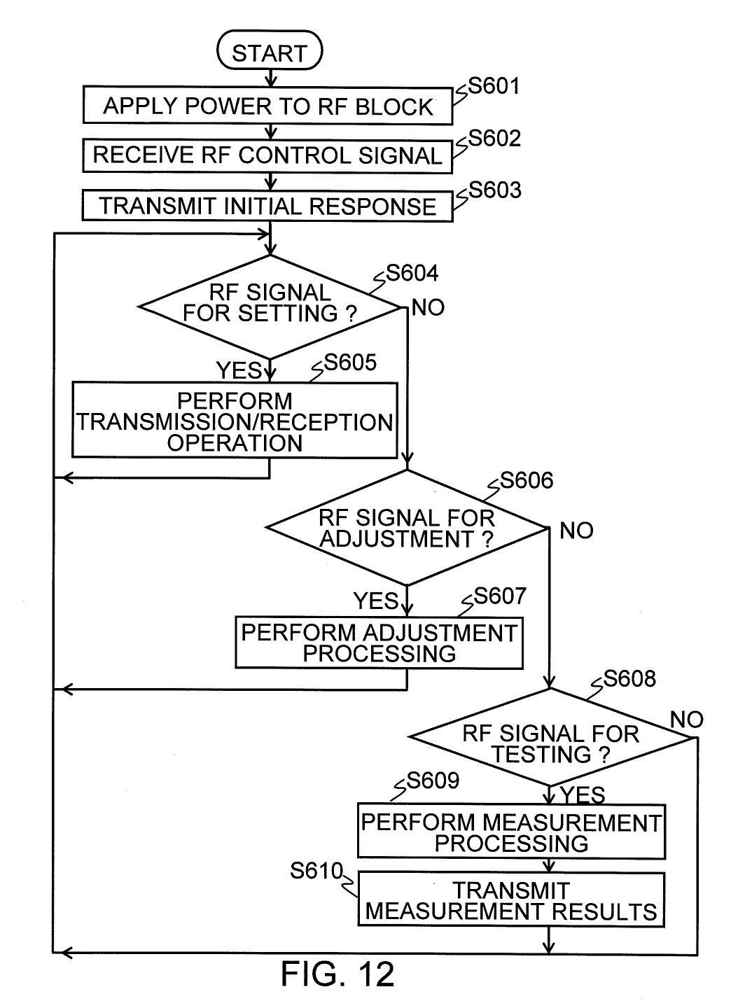

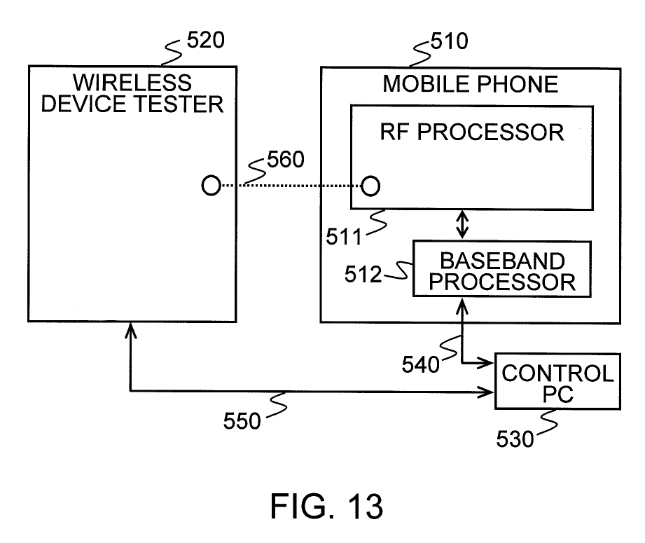

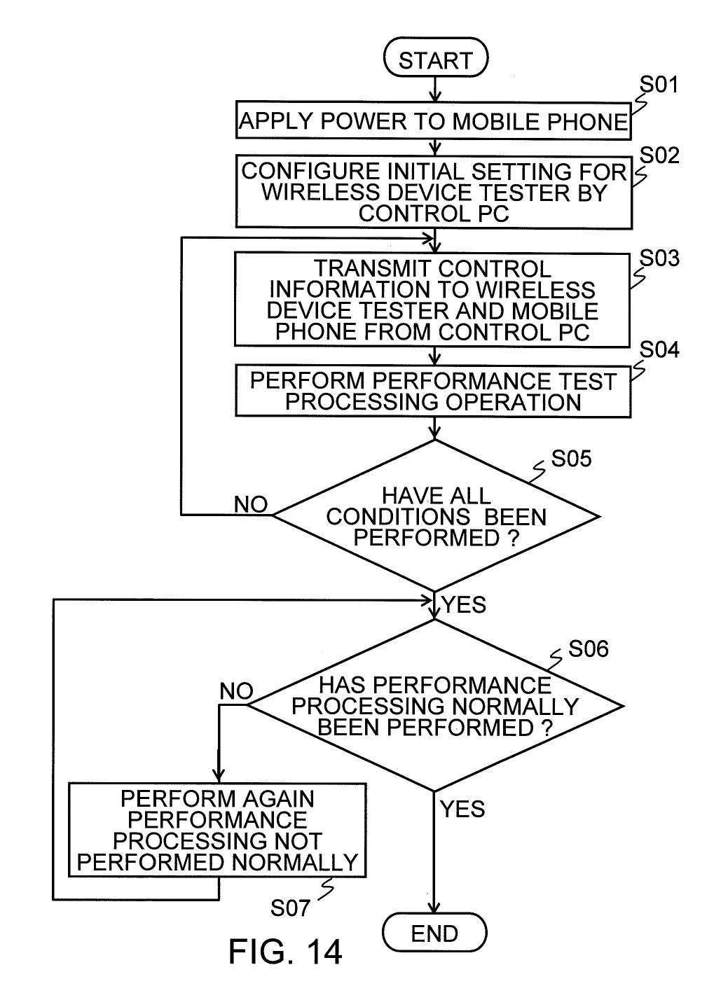

Next, the detailed operation of the mobile phone 1 will be described with reference to FIG. 12 which is a flowchart illustrating operating procedures performed in the mobile phone 1 according to the second embodiment. In FIG. 12, only operating procedures relating to the wireless adjustment/test are illustrated from among operating procedures performed by the RF-LSI 17.

As illustrated in FIG. 12, when power is applied to the RF processor 10 (Step S601), the RF-LSI 17 receives from the wireless device tester 2 the RF control signal indicating the start of the wireless adjustment/test (Step S602). When power is applied to the RF processor 10, the RF-LSI 17 moves to a state in which the RF-LSI 17 may automatically receive the RF signal from the wireless device tester 2. When receiving the RF signal indicating the start of the wireless adjustment/test, the RF-LSI 17 transmits the initiation response of the wireless adjustment/test to the wireless device tester 2 (Step S603).

When transmitting the initiation response of the wireless adjustment/test to the wireless device tester 2, the RF-LSI 17 determines whether or not the RF control signal used for an operation setting is received (Step S604). Specifically, when the control information extracted from the RF control signal by the controller 111 is the control signal used for an operation setting, the RF-LSI 17 determines that the RF control signal used for an operation setting is received. When, in the operation, it is determined that the RF control signal used for an operation setting is received (Step S604 affirmative), the RF-LSI 17 performs a transmission/reception operation for the RF signal on the basis of the control information extracted from the RF control signal (Step S605).

Specifically, when the content of the control information extracted from the RF control signal indicates that a test-use RF signal is to be transmitted, the RF-LSI 17 transmits to the wireless device tester 2 the test-use RF signal with the transmission frequency and the transmission power or the like specified by the control information. When the content of the control information extracted from the RF control signal indicates that a reception operation for the test-use RF signal is to be performed, the RF-LSI 17 moves to a reception standby state in which the RF-LSI 17 stands by for the reception of the test-use RF signal transmitted from the wireless device tester 2. In addition, the RF-LSI 17 measures the reception frequency and the reception power or the like of the test-use RF signal received from the wireless device tester 2 and transmits the measurement result to the wireless device tester 2.

On the other hand, when it is determined that the RF control signal used for an operation setting is not received (Step S604 negative), the RF-LSI 17 determines whether or not the RF control signal used for wireless communication performance adjustment is received (Step S606). When, in this operation, it is determined that the RF control signal used for wireless communication performance adjustment is received (Step S606 affirmative), the RF-LSI 17 performs the wireless communication performance adjustment in accordance with the content of the received RF control signal (Step S607). For example, the controller 111 in the RF-LSI 17 modifies a setting value used for the power amplification factor of the RF signal for the PA 15.

On the other hand, when it is determined that the RF control signal used for wireless performance adjustment is not received (Step S606 negative), the RF-LSI 17 determines whether or not the test-use RF control signal is received (Step S608). When it is determined that the test-use RF control signal is received (Step S608 affirmative), the RF-LSI 17 performs a measurement operation for the received test-use RF signal (Step S609) and transmits the measurement result to the wireless device tester 2 (Step S610).

When the operations in Steps S605, S607, or S610 is completed or it is determined that the test-use RF signal is received (Step S608 negative), the RF-LSI 17 shifts the operation to Step S604.

As mentioned above, in the performance test system S according to the second embodiment, the operation of the RF-LSI 17 is controlled by the RF control signal transmitted from the wireless device tester. Accordingly, the wireless adjustment/test is performed without using the BB-LSI 18. Therefore, in the performance test system S, the test time may be reduced by omitting the time necessary for activating the BB-LSI 18 that is not the object of the performance test. Further, a processing time taken in the mobile phone 1 may be reduced. As a result, in the performance test system S according to the second embodiment, a time necessary for the performance test may be reduced.

In addition, in the performance test system S according to the second embodiment, the mobile phone 1 sends the notice of a setting response to the operation setting of the RF processor 10 only when the wireless adjustment/test is started. Therefore, in the performance test system S according to the second embodiment, a time necessary for waiting for the setting response from the mobile phone 1 may be reduced in comparison with the case in which the control PC 3 controls the operation of the RF-LSI 17.

In addition, in the performance test method according to the first embodiment, it is not necessary for the individual control PCs 3 to be provided for the individual mobile phones 1. Therefore, in the performance test system S according to the second embodiment, the performance test may be efficiently performed even for the multiple wireless communication devices 60.

While, as above, the embodiments of the present invention are described in detail on the basis of figures, these embodiments are examples. Furthermore, in the embodiments of the present invention, the various changes, substitutions, and improved alterations may be made hereto on the basis of the embodiments disclosed in the specification and the knowledge of those skilled in the art.

For example, in the second embodiment, while the RF-LSI 17 has the configuration corresponding to only one band in an universal mobile telecommunications system (UMTS), a configuration in which a UTMS function and a global system for mobile communications (GSM) function are integrated into one chip may be adopted. In addition, the RF-LSI 17 may be a multiband-compliant device.

Further, the RF processor 10 and the wireless device tester 2 transmit and receive various kinds of RF signals to and from each other through the RF cable 4. However, while the embodiments are not limited to the example, the RF signals may be transmitted and received between the ANT 11 in the RF processor 10 and an antenna, not illustrated, in the wireless device tester 2.

In addition, when extracting the control information from the RF control signal, the controller 111 recognizes the RF signal having a high output level as data having a value “1”, and the RF signal having a low output level as data having a value “0”. However, the controller 111 may recognize the RF signal having a high output level as data having a value “0”, and the RF signal having a low output level as data having a value “1”.

In addition, in the second embodiment, while the wireless device tester 2 determines whether or not it is necessary to perform the wireless communication performance adjustment, the embodiment is not limited to the example. For example, the wireless device tester 2 may transmit to the control PC the measurement result of the wireless communication performance measurement performed in Step S405 illustrated in FIG. 10, and, on the basis of the measurement result, the control PC 3 may determines whether or not it is necessary to perform the wireless communication performance adjustment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless communication performance test method for testing a performance of a wireless processor which is arranged in a wireless transmission device for performing a transmission and reception operation of a wireless signal, comprising:
transmitting, to the wireless processor, a wireless signal including control information for controlling the transmission and reception operation performed by the wireless processor from a wireless transmission test use measurement device for measuring a wireless transmission performance of the wireless processor;
performing the transmission and reception operation in the wireless processor based on the control information extracted from the wireless signal transmitted from the wireless transmission test use measurement device; and
measuring the wireless signal transmitted and received in the transmission and reception operation performed by the wireless processor.

2. The wireless communication performance test method according to claim 1, wherein a transmission operation in the transmission and reception operation is executed in order to transmit a wireless signal to the wireless transmission test use measurement device based on the control information extracted from the wireless signal when the control information extracted from the wireless signal includes information for a transmission operation of the wireless signal by the wireless processor and a wireless signal transmitted from the wireless processor based on the transmission and reception operation is measured, in the operation of measuring, by the wireless transmission test use measurement device.

3. The wireless communication performance test method according to claim 1, wherein a reception operation in the transmission and reception operation is executed in order to receive a wireless signal based on the control information extracted from the control information when the control information extracted from the wireless signal includes information for the reception operation of the wireless signal by the wireless processor and a wireless signal received in the reception operation by the wireless processor is measured by the wireless transmission device in order to send a measurement result of the wireless signal to the wireless transmission test use measurement device.

4. The wireless communication performance test method according to claim 2, wherein a reception operation in the transmission and reception operation is executed in order to receive a wireless signal based on the control information extracted from the control information when the control information extracted from the wireless signal includes information for the reception operation of the wireless signal by the wireless processor and a wireless signal received in the reception operation by the wireless processor is measured by the wireless transmission device in order to send a measurement result of the wireless signal to the wireless transmission test use measurement device.

5. The wireless communication performance test method according to claim 1, wherein the wireless signal in the operation of transmitting is transmitted to the wireless processor, the wireless signal being a wireless signal which is generated by amplitude modulating the control information which is bit data including a value 1 or a value 2; and in the transmission and reception operation, an amount of an amplitude of the wireless signal transmitted is detected and the control information is extracted from the wireless signal, the control information as data including the value 1 or the value 0 by determining, using a certain threshold, whether the amount is a high value or a low.

6. The wireless communication performance test method according to claim 2, wherein the wireless signal in the operation of transmitting is transmitted to the wireless processor, the wireless signal being a wireless signal which is generated by amplitude modulating the control information which is bit data including a value 1 or a value 2; and in the transmission and reception operation, an amount of an amplitude of the wireless signal transmitted is detected and the control information is extracted from the wireless signal, the control information as data including the value 1 or the value 0 by determining, using a certain threshold, whether the amount is a high value or a low.

7. The wireless communication performance test method according to claim 3, wherein the wireless signal in the operation of transmitting is transmitted to the wireless processor, the wireless signal being a wireless signal which is generated by amplitude modulating the control information which is bit data including a value 1 or a value 2; and in the transmission and reception operation, an amount of an amplitude of the wireless signal transmitted is detected and the control information is extracted from the wireless signal, the control information as data including the value 1 or the value 0 by determining, using a certain threshold, whether the amount is a high value or a low.

8. The wireless communication performance test method according to claim 1, wherein a certain wireless signal is transmitted to the wireless transmission device before the wireless signal as the control information is transmitted in the operation of transmitting; and the control information is extracted, in the transmission and reception operation, from a wireless signal received after receiving the certain wireless signal.

9. The wireless communication performance test method according to claim 2, wherein a certain wireless signal is transmitted to the wireless transmission device before the wireless signal as the control information is transmitted in the operation of transmitting; and the control information is extracted, in the transmission and reception operation, from a wireless signal received after receiving the certain wireless signal.

10. The wireless communication performance test method according to claim 3, wherein a certain wireless signal is transmitted to the wireless transmission device before the wireless signal as the control information is transmitted in the operation of transmitting; and the control information is extracted, in the transmission and reception operation, from a wireless signal received after receiving the certain wireless signal.

11. The wireless communication performance test method according to claim 4, wherein a certain wireless signal is transmitted to the wireless transmission device before the wireless signal as the control information is transmitted in the operation of transmitting; and the control information is extracted, in the transmission and reception operation, from a wireless signal received after receiving the certain wireless signal.

12. The wireless communication performance test method according to claim 1, wherein the wireless processor includes a memory for storing test pattern data; and
the test pattern data is read out, in the transmission and reception operation, from the memory based on the control information extracted from the wireless signal transmitted in the operation of transmitting and a wireless signal is generated, in the transmission and reception operation, based on the test pattern data to be sent to the wireless transmission test use measurement device.

13. The wireless communication performance test method according to claim 2, wherein the wireless processor includes a memory for storing test pattern data; and
the test pattern data is read out, in the transmission and reception operation, from the memory based on the control information extracted from the wireless signal transmitted in the operation of transmitting and a wireless signal is generated, in the transmission and reception operation, based on the test pattern data to be sent to the wireless transmission test use measurement device.

14. The wireless communication performance test method according to claim 3, wherein the wireless processor includes a memory for storing test pattern data; and
the test pattern data is read out, in the transmission and reception operation, from the memory based on the control information extracted from the wireless signal transmitted in the operation of transmitting and a wireless signal is generated, in the transmission and reception operation, based on the test pattern data to be sent to the wireless transmission test use measurement device.

15. The wireless communication performance test method according to claim 4, wherein the wireless processor includes a memory for storing test pattern data; and
the test pattern data is read out, in the transmission and reception operation, from the memory based on the control information extracted from the wireless signal transmitted in the operation of transmitting and a wireless signal is generated, in the transmission and reception operation, based on the test pattern data to be sent to the wireless transmission test use measurement device.

16. The wireless communication performance test method according to claim 5, wherein the wireless processor includes a memory for storing test pattern data; and
the test pattern data is read out, in the transmission and reception operation, from the memory based on the control information extracted from the wireless signal transmitted in the operation of transmitting and a wireless signal is generated, in the transmission and reception operation, based on the test pattern data to be sent to the wireless transmission test use measurement device.

17. A wireless transmission test use measurement device comprising:
a transmitter configured to transmit, to a wireless processor, a first wireless signal including control information for controlling a transmission and reception operation of a wireless signal performed by the wireless processor arranged in the wireless transmission device; and
a measurement processor configured to measure the first wireless signal transmitted in the transmission and reception operation.

18. A wireless communication performance test system comprising:
a wireless communication device including a wireless processor performing a transmission and reception operation of a wireless signal; and
a wireless transmission test use measurement device including,
a transmitter configured to transmit, to the wireless processor, a first wireless signal including control information for controlling the transmission and reception operation of the wireless signal performed by the wireless processor, and
a measurement processor configured to measure the first wireless signal transmitted from the wireless communication device by the transmission and reception operation,
wherein the wireless processor performs the transmission and reception operation based on the control information extracted out of the first wireless signal transmitted from the transmitter.
